(19) United States
(12) Patent Application Publication
(10) Pub. No.: US 2022/0109655 A1
(43) Pub. Date: Apr. 7, 2022

(54) SECURE MANUFACTURING OPERATION

(71) Applicant: The Procter & Gamble Company, Cincinnati, OH (US)

(72) Inventors: Mark Wayne Morrow, Williamsburg, OH (US); Micah Joshua Arthur, Crescent Springs, KY (US); Geoffrey John Kerr, Geneva (CH)

(21) Appl. No.: 17/374,064

(22) Filed: Jul. 13, 2021

Related U.S. Application Data
(60) Provisional application No. 63/087,357, filed on Oct. 5, 2020.

(51) Int. Cl. H04L 29/06

(52) U.S. Cl. CPC H04L 63/0218; H04L 63/0227; H04L 63/20; H04L 63/0428; H04L 63/145

(57) ABSTRACT

Increasing security of a group of automated devices includes designating, by a processor, a host machine to provide a communication path for each of the group of automated devices and a communication-capable resource; limiting communication between each of the group of automated devices and a) any communication-capable resource other than the group of automated devices, or b) at least some members of the group of automated devices, to the communication path provided by the host machine; monitoring, by the host machine, at least a first communication characteristic or pattern related to any one of the group of automated devices; identifying, by the host machine, a communication-related anomaly in the monitored first communication characteristic or pattern; and providing, by the host machine, an alert when the communication-related anomaly is identified.

### BACKGROUND

Internet security (IS) has become a common concern as the Internet-of-Things (IoT) and electronic communications continue to become part of more and more activities and devices. Hardware and software developed for IS include firewalls and anti-virus software. Further, IS Architectures may be designed and developed that support entire organizations and networks. This creates the possibility that a cyber-infiltration in one part of the network can spread to the remainder of the network.

IS Architectures are typically built from a combination of software and hardware (and Virtual machines). Typical examples of hardware include Firewalls and network segmentation. Typical examples of software include anti-virus (AV), anti-malware (AM), Host based Intrusion Detection Systems (IDS), and Host base Intrusion Prevention Systems (IPS). Each of these hardware and software choices present benefits and costs such that selecting an implementation often includes trade-offs. One such trade-off is the speed of communications versus the level of permissiveness of firewalls. Another such trade-off is breadth of access (i.e. Internet access) versus risk of infiltration. As such, IS Architectures may be uniquely designed and implemented for their operating environments.

### SUMMARY

One aspect of the present disclosure relates to a processor-implemented method of increasing security of a group of automated devices that includes designating, by a processor, a host machine to provide a communication path for each of the group of automated devices and a communication-capable resource; limiting communication between each of the group of automated devices and a) any communication-capable resource other than the group of automated devices, or b) at least some members of the group of automated devices, to the communication path provided by the host machine. The method continues with monitoring, by the host machine, at least a first communication characteristic or pattern related to any one of the group of automated devices; identifying, by the host machine, a communication-related anomaly in the monitored first communication characteristic or pattern; and providing, by the host machine, an alert when the communication-related anomaly is identified,

This aspect also includes establishing by the designated host machine an expected communication characteristic or pattern related to one or more of the group of automated devices; and wherein identifying the communication-related anomaly comprises identifying a deviation of the monitored first communication characteristic or pattern from the expected communication characteristic or pattern.

Also, the communication path provided by the host machine can include a communication channel between the processor and the host machine such that communication between any communication-capable resource and at least one automated device of the group of automated devices is limited to the processor and the communication channel; and the alert can include disabling, by the processor or the host machine, the communication channel.

Furthermore, at least one of the group of automated devices comprises an operating system without anti-virus capability, or at least one of the group of automated devices comprises an operating system without security-related capability.

Also, the group of automated devices are networked with one another to provide a logical functional element and the group of automated devices can define a manufacturing operation.

This aspect also includes monitoring, by the host machine, at least a second communication characteristic or pattern related to communications within the group of automated devices and identifying, by the host machine, a communication-related anomaly in the monitored second communication characteristic or pattern.

The first communication characteristic or pattern can include one of data volume, data content, data destination location, or a change in the group of automated devices. Also, the communication path for each of the group of automated devices and a communication-capable resource can include a two-way communication path.

According to this aspect, identifying the communication-related anomaly may comprise identifying a malware signature in the monitored first communication characteristic or pattern.

Another aspect of the present disclosure relates to a processor-implemented method of increasing security of a group of automated manufacturing devices that includes designating a host machine to provide a communication path for each of the group of automated manufacturing devices; and limiting communication between each of the group of automated manufacturing devices and a) any communication-capable resource other than the group of automated manufacturing devices, or b) at least some members of the group of automated manufacturing devices, to the communication path provided by the host machine.

Yet a further aspect of the present disclosure relates to a system for increasing security of a group of automated devices comprising a processor-based device comprising: a first memory device storing first executable instructions; and a first processor in communication with the first memory device; along with a host machine comprising: a second memory device storing second executable instructions; and a second processor in communication with the second memory device. The first processor, when executing the first executable instructions, designates the host machine to provide a communication path for each of the group of automated devices and wherein connectivity is limited to the communication path provided by the host machine for communications between each of the group of automated devices and a) any communication-capable resource other than the group of automated devices, or b) at least some members of the group of automated devices. The second processor, when executing the second executable instructions: monitors at least a first communication characteristic or pattern related to any one of the group of automated devices and the host machine; identifies a communication-related anomaly in the monitored first communication characteristic or pattern; and provides an alert in response to the communication-related anomaly.

This aspect also includes establishing by the second processor an expected communication characteristic or pattern related to one or more of the group of automated devices; and wherein identifying the communication-related anomaly comprises identifying a deviation of the monitored first communication characteristic or pattern from the expected communication characteristic or pattern.

Also, the communication path provided by the second processor can include a communication channel between the first processor and the second processor such that communication between any communication-capable resource and at least one automated device of the group of automated devices is limited to the first processor and the communication channel; and the alert can include disabling the communication channel in response to the anomaly.

Furthermore, at least one of the group of automated devices comprises an operating system without anti-virus capability, or at least one of the group of automated devices comprises an operating system without security-related capability.

Also, the group of automated devices are networked with one another to provide a logical functional element and the group of automated devices can define a manufacturing operation.

This aspect also includes monitoring, at least a second communication characteristic or pattern related to communications within the group of automated manufacturing devices; and identifying a communication-related anomaly in the monitored second communication characteristic or pattern.

The first communication characteristic or pattern can include one of data volume, data content, data destination location, or a change in the group of automated devices. Also, the communication path for each of the group of automated devices and a communication-capable resource can include a two-way communication path.

According to this aspect, identifying the communication-related anomaly may comprise identifying a malware signature in the monitored first communication characteristic or pattern.

A further aspect of the present disclosure relates to a system for increasing security of a group of automated devices comprising a processor-based device comprising: a first memory device storing first executable instructions; and a first processor in communication with the first memory device; along with a host machine comprising: a second memory device storing second executable instructions; and a second processor in communication with the second memory device. The first processor, when executing the first executable instructions designates the host machine to provide a communication path for each of the group of automated devices and wherein connectivity is limited to the communication path provided by the host machine for communications between each of the group of automated devices and a) any communication-capable resource other than the group of automated manufacturing devices, or b) at least some members of the group of automated devices.

### BRIEF DESCRIPTION OF THE SEVERAL VIEWS OF THE DRAWINGS

FIG. 1 is a block-level depiction of a manufacturing environment within an enterprise;

FIG. 2A is a block-level depiction of a manufacturing environment within an enterprise according to the principles of the present disclosure;

FIG. 2B is a block level diagram inside of a secured zone according to the principles of the present disclosure;

FIG. 3 depicts one method according to the principles of the present disclosure;

FIG. 4 depicts another method according to the principles of the present disclosure; and

FIG. 5 is a block diagram of a data processing system in accordance with the principles of the present disclosure.

### DETAILED DESCRIPTION

In the following detailed description of the illustrated embodiments, reference is made to the accompanying drawings that form a part hereof, and in which is shown by way of illustration, and not by way of limitation, specific embodiments in which the invention may be practiced. It is to be understood that other embodiments may be utilized and that changes may be made without departing from the spirit and scope of various embodiments of the present disclosure.

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely as hardware, entirely as software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CORaM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, CII, VB.NET, Python or the like, conventional procedural programming languages, such as the “c” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

There are a number of activities that an IS system can perform in securing the networks and environments of an enterprise to which they are applied. These activities, for example can include: Threat Detection; Asset Registration; Malware and Intrusion Protection; Vulnerability Scanning; Event Logging and Monitoring; Network and System Access Management; and User-Identity Management.

An Enterprise may comprise a corporation or other business or organizational entity having manufacturing capabilities. The Enterprise may comprise an Enterprise, or information technology (IT), zone and a manufacturing environment, Manufacturing Zone, or Operational Technology (OT) environment. The Enterprise or IT zone may comprise IT systems of the Enterprise, such as personnel computers, an email system, one or more websites, and other computer-based resources not directly part of a group of OT devices which define a manufacturing cell or line. In general, an Enterprise can refer to almost any organization and embodiments described herein contemplate protection of systems such as in an R&D facility, an oil refinery, power generation plant, or a water treatment plant (waste or potable water). The techniques described herein can also be used in IT systems, protecting in a similar fashion computer systems that are directly connected to the manufacturing zone for data collection, data historians, warehouse management systems that control physical equipment such as automated fork trucks, and automatic guided vehicles.

Many IS architectures are known today. One common Architecture includes “Host Based” systems in which each device independently maintains its own IS software. Host based systems are commonly used, for example, in “Enterprise Zones,” where the primary communications activities include sharing of information (i.e. emails, chats, etc.) over an enterprise network. IS Architecture for an Enterprise Zone may further include firewalls both within the Zone (e.g. to manage ordinary versus classified information storage and communication) and at the periphery of the zone (e.g. to manage access to the Internet). Each device connected to the enterprise network includes an operating system (e.g. MS Windows), and the IS on each device can be maintained as a software component within that operating system. As such, any breach of the enterprise network is mitigated at the individual devices connected to the network and any updates to the IS software are managed at the point of the individual device.

In contrast, “Manufacturing Zones” present a unique challenge to IS Architectures in that many of Operational Technology (OT) devices used in Manufacturing Zones employ operating systems (e.g., programmable logic controllers (PLCs)) that do not include IS software. These devices typically co-exist in the Manufacturing Zone with other OT devices that execute typical contemporary business operating systems such as, for example, MS Windows-like Information Technology (IT) systems or Linux-based systems. In general, as described herein, such OT devices, which may be Windows-based, Linux-based, or based on an operating systems with similar capabilities, are often referred to as “contemporary business systems,” “business IT systems, or just “business systems.” IS architectures that rely on systems and devices such as these executing their own IS functions suffer from a disadvantage. The business IT systems and devices that have IS software running on them as a part of the IS Architecture, have to be updated or “patched” from time-to-time so that the IS protection is up-to-date, given that IS threats change constantly. These updates are problematic to the manufacturing environment, or manufacturing zone, as they often require the corresponding manufacturing process to be shut-down during an update. Further, different systems or devices may have different software running on them which may require updating at different times. Further the updates often require direct-access to the Internet, which raises the possibility that cyber-threats may have access to the devices or systems in the manufacturing zone. As such, OT devices in such an IS architecture (e.g. a host based IS architecture) are at risk of either being poorly protected, or unprotected, from cyber-threats.

OT devices common in a Manufacturing Zone include: Vision cameras, Human Machine Interfaces (HMI), PLC programming stations, MS Windows based control applications; Programmable Logic Controllers, robots, motor controllers, smart sensors/actuators, etc. Many of these OT devices are not capable of using host-based IS technology as described above.

Some, part or all of the manufacturing cells or lines may include a track-based system such as that described in U.S. Pat. Nos. 10,640,249, 10,640,345, 10,643,875, 10,558,201, the disclosures of which are incorporated, by reference, in their entirety. The track-based system may include vehicles that move articles along a track among varying operating stations where manufacturing operations may be conducted. The vehicles may be propelled along the track by linear motors such as linear synchronous motors. Manufacturing operations that may be performed on the track-based system include but are not limited to bottle-handling operations such as loading, conveying, filling, mixing, labeling, capping, un-loading and the like. Manufacturing operations may include assembly operations such as the handling and joining of component parts to assemble a finished article such as part placement, part holding, joining (e.g. welding, gluing, stitching, sealing), rotating, folding, unloading and the like.

As such, a host based IS Architecture can be undesirable in a Manufacturing Zone as the protection is limited, and the updates to the IS software can be disruptive to the corresponding manufacturing process, which may run continuously 24/7.

One strategy for managing the difficulties of such an IS architecture is to group the OT devices and systems that include the IS software with the related OT devices and systems without the IS software so that they are segmented from other groups. Designing IS Architectures for OT devices in a Manufacturing Zone that includes segmenting the OT devices into smaller groups allows for closer management of the IS and, in the event of a breach, can limit the extent of the breach in terms of the number of OT devices affected. This architecture still suffers from the disadvantages of a host-based system, though there are fewer points to execute updates and fewer opportunities for cyber-threats.

Embodiments in accordance with the present disclosure contemplate a wide variety of possible automated manufacturing devices, or OT devices, that, for example, can include a Warehouse management system server; a Manufacturing execution system server; an Area Supervisory controller; a Programmable Logic Controller; a Batch Control System; a Continuous Making Control System; Distributed Control Systems; Motion Control Systems; Drive and other actuator controllers; Servo and drive amplifiers; Smart/network connected/microprocessor controlled field sensors (pH, viscosity, level, scales, temperature, color, position, velocity, surface speed, proximity, photoelectric, vision camera, UV sensor, RF sensors, barcode scanners, light curtain, safety sensors); Smart/network connected/microprocessor controlled field actuators (servo, AC/DC motor, Linear actuator, Curvilinear motors, pneumatic, hydraulic, electric actuators, robots, automatic guided vehicles); Network routers, switches, hubs, edge computers; and/or User Interfaces (commercial operating system based applications, proprietary user interfaces, other dedicated display devices).

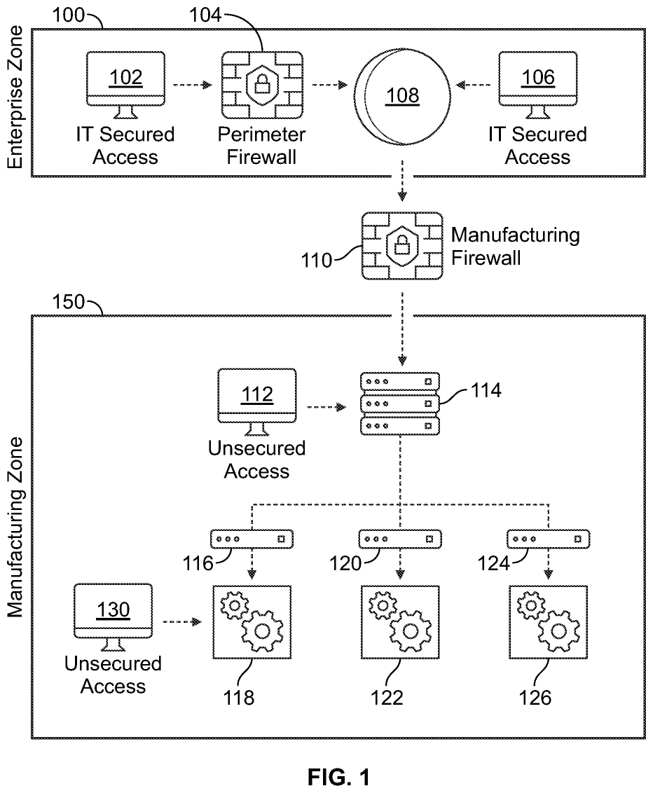

FIG. 1 is a block-level depiction of an Enterprise, or IT, zone 100 and a manufacturing environment, Manufacturing Zone 150, or OT environment, wherein both the IT zone 100 and the Manufacturing Zone 150 are within an enterprise that has access to the internet, wherein the enterprise may comprise a corporation or other business or organizational entity, which does manufacturing. Additionally, embodiments of the present disclosure contemplate that rather than the Enterprise Zone being separate from the Manufacturing Zone, the OT/manufacturing groups can be connected directly to the Enterprise zone or there is not a differentiation between Enterprise IT and Manufacturing zones such that they may sometimes comprise the same mixed/combined networks/zones. Activities that might take place within the Enterprise zone 100 may include planning, reporting, human resources, and the like, which require frequent and varying connections among the devices and systems within an enterprise network as well as remote connections to remote systems such as via the Internet. A host based IS architecture may be more appropriate in an Enterprise Zone than in a Manufacturing Zone given the high variability in connections that are required to perform the intended functions of the enterprise in the Enterprise Zone.

A remote system 102 comprising, for example, an operating system, user application software and network connectivity capability, can be located on the internet but can access an enterprise network 108 through a firewall 104. The firewall 104 can be configured by IT personnel of the enterprise to provide a desired level of security when accessing the enterprise network 108. Internal to the Enterprise zone 100 can be a system 106 comprising, for example, an operating system, user application software and network connectivity capability, that can access the enterprise network 108 without needing to traverse the firewall 104. Separate from the Enterprise zone 100 is the Manufacturing Zone 150 that includes OT devices and processes. The Manufacturing Zone 150 can be separated from the Enterprise zone 100 by a different firewall 110. The “manufacturing firewall” 110 can be configured by administrative or IT personnel to limit access between the systems and devices of the Manufacturing Zone 150 and the systems and devices of the IT, or enterprise zone 100.

Within the manufacturing zone 150 there can be one or more network access devices (e.g., switches and/or routers). For example, the communications network within the Manufacturing Zone 150 may be configured as shown in FIG. 1 with one or more network access devices 114 that connect with one or more respective network access device (e.g., switches and/or routers) 116, 120, 124. Each of the respective network access devices 116, 120 and 124 is associated with a different manufacturing line or cell 118, 122, and 126. Although not shown in detail in FIG. 1, each manufacturing line or cell 118, 122, 126 is comprised of one or more OT devices, with or without IS software. The figures described herein focus on typical “wired” network connections for the sake of clarity. One of ordinary skill, however, will readily recognize that wireless connections are also typical types of connections to the OT zones and devices, and that portions of, or all of, the depicted networks and connections can utilize wireless technologies without departing from the scope of the present disclosure.

The network configuration depicted in FIG. 1 allows at least two vulnerabilities for the Manufacturing Zone 150. A system 112 comprising, for example, an operating system, user application software and network connectivity capability, which may be physically present within, near, or otherwise connected to the Manufacturing Zone 150, can be connected, such as via a network connection, to the one or more network access devices 114, 116, 120, 124. Accordingly, the system 112 may introduce malware or a virus into the network of the Manufacturing Zone 150 which can reach the manufacturing lines or cells 118, 122 and 126. Separately, a system 130 comprising, for example, an operating system, user application software and network connectivity capability, which may be physically present, near, or otherwise connected to a manufacturing line or cell 118, 122, 126 can be connected with an OT device within the manufacturing line or cell 118, 122, 126, thereby providing for the risk that malware or a virus may be introduced into the network of the Manufacturing Zone 150.

The connection of the offending system 112 or system 130 to a network device (114, 116, 120, 124) or an OT device within one of the manufacturing lines or cells (118, 122, 126) can include a Wi-Fi, Bluetooth, serial, network, or USB connection. Thus the systems 112 and 130, for example, can be considered generally as a communication capable resource, which can communicate using any of a variety of various methods with one or more of the OT devices within a manufacturing line or cell 118, 122, 126.

If the communication capable resource 112 or 130 is able to, purposefully or inadvertently, introduce malware or a virus, for example, within one or more of the network devices (114, 116, 120, 124) or OT devices of a manufacturing line or cell 118, 122, 126, then that same security threat can be transmitted to the network access devices 116, 120, 124, the other manufacturing lines or cells, and possibly to the enterprise zone 100.

Thus, while FIG. 1 is a schematic depiction of one approach of segmenting a manufacturing operation, there remains a need for an OT IS Architecture that prevents cyber-threats against OT devices (including PLC devices, and host-type devices, such as contemporary business systems) in a Manufacturing Zone and a system or device to provide alerts and possibly take automatic action in the event that an anomalous connection is made into, out-from or within the Manufacturing Zone 150 or some other communication-related anomaly occurs. As one example, a communication related anomaly can include a malware signature in communications in a connection that is made into, out-from or within the Manufacturing Zone 150.

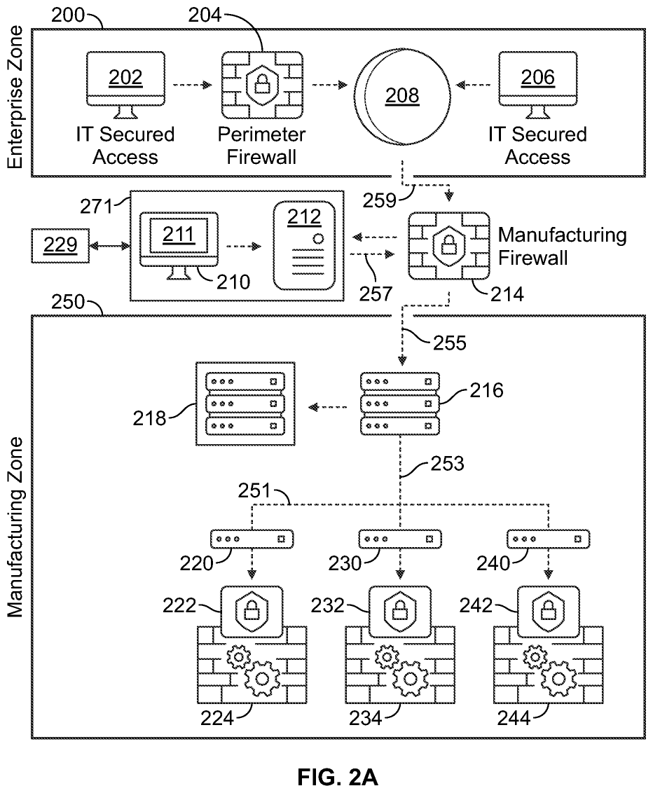

FIG. 2A is a block-level depiction of a Manufacturing Zone within an enterprise according to the principles of the present disclosure. The contemplated Manufacturing Zone of FIG. 2A can comprise an IS Architecture for a Manufacturing Zone 250 that employs specific hardware, software, and connectivity within and among different “Secured zones”, “Manufacturing Lines”, “Manufacturing Cells”, “Manufacturing Operations”, or “Operating Zones” within the Manufacturing Zone.

As mentioned above, some example OT devices common in a Manufacturing Zone include: Vision cameras, Human Machine Interfaces (HMI), PLC programming stations, MS Windows based control applications; Programmable Logic Controllers, robots, motor controllers, smart sensors/actuators, etc. Many of these OT devices are not capable of using Host-based IS technology as described above.

One particular aspect is that a group of automated manufacturing devices such as, for example, the OT devices (including PLC devices and contemporary business systems) described above, can be grouped or segmented so as to define “Operating Zones,” which are secured to define “Secured Zones.” Thus, each Operating Zone is secured. Within each Secured Operating Zone, there is generally no connectivity or possibility of connectivity (i.e. no Wi-Fi connections, Bluetooth connections, or accessible plug-ports such as USB's, etc.) between any of the contemporary business systems or other non-host based OT devices and any non-OT communication capable resource within the secured zone, except through a host machine 222, 232, 242, each of which can also be referred to as a “line box”. There is the possibility of at least some communications between two OT devices within a secured operating zone, which communications do not pass through a host machine. Similarly, there is no connectivity and no possibility of connectivity of any of the contemporary business systems or other non-host OT devices to any device outside of the Secured Operating Zone (i.e., no connectivity to the Internet) except through a specific communication path that comprises its corresponding host machine 222, 232, 242. Said another way, the host machines 222, 232, 242 provide for all communication pathways of the contemporary business systems or non-host based OT devices in the Secured Operating Zone to a device outside of the Secured Operating Zone. As such, each OT device in the Secured Zone, except for some communications with other OT devices also within the Secured Zone, has only one connection, e.g., one outside connection, or possibility of connection and that one connection is to, or through, the host machine 222, 232, 242. The connection is preferably a hard connection (i.e., a wire). In some instances, as described herein, communications involving the contemporary business systems and other non-host based OT devices with each other in a secured operating zone may be limited to using the line box 222, 232, 242 as well.

FIG. 2A includes an enterprise, or IT, zone 200 that allows systems 202 and 206, each, for example, comprising an operating system, user application software and network connectivity capability, to access an enterprise network 208. Similar to FIG. 1, access of the system 202 to the enterprise network 208 may be controlled by an enterprise firewall 204. Also, similar to FIG. 1, the schematic of FIG. 2A includes a manufacturing firewall 214 that separates, or limits, network traffic between the enterprise zone 200 and a manufacturing, or OT, zone 250. Thus, network traffic from the enterprise zone 200 directed at the Manufacturing Zone may be limited to a communication path 259 that connects the enterprise zone 200 with the manufacturing firewall 214. Also similar to FIG. 1, the Manufacturing Zone comprises one or more network access devices (216, 220, 230, 240).

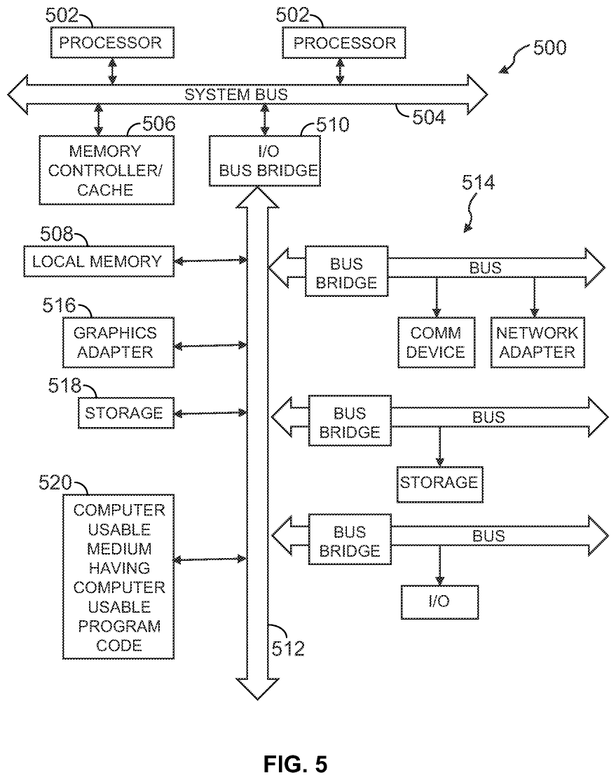

In FIG. 2A, there is a secure access management function 271 implemented through a data processing system 210 comprising a processor 211 and associated storage 212. The data processing system 210 can, for example, be implemented as described below using hardware depicted in FIG. 5. The system 210 is located separately, in FIG. 2A, from both the enterprise zone 200 and the manufacturing zone 250. However, this system 210 and its provided secure access management function 271 can be provided withing the enterprise zone 200 or the manufacturing zone 250, as well.

The system 210 for effecting the secure access management function 271 allows a user to communicate via a network connection 257 with the manufacturing firewall 214. This allows the user to communicate (through the firewall 214) with one or more networks within the manufacturing zone 250. In particular, a communication path 255 provides access to one or more network access devices 216 which can communicate with a group of network access devices (e.g., switches and/or routers) 220, 230 and 240 and optionally an associated storage 218 which may also be physically present, near or otherwise connected to the manufacturing zone. The storage 218 of FIG. 2A may represent a local cloud that can store data associated with the manufacturing zone 250. Embodiments of a local cloud can include a server with attached storage or a dedicated cloud of storage devices 218 that are physically present, near or otherwise connected to the manufacturing zone 250. The secure access management function 271 can place data items in the local cloud 218 and/or retrieve information from the local cloud 218.

The manufacturing firewall 214 may be configured by IT personnel, or OT personnel, of the enterprise to assign different permissivities to the communication pathways 259, 257 (respectively) from the Enterprise Zone 200 and the secure access management function 271. For example, communications from the enterprise zone may be more highly restricted by the manufacturing firewall 214 than that from the data processing system 210. Other varying permissiveness can depend on the type of communication passing through the firewall 214. In some instances, programmatic, or autonomous, processes and/or applications on systems within the enterprise zone 200 may try to access or communicate with one or more resources within the manufacturing zone 250; and vice-versa. Other communications may, alternatively, be user-initiated from the enterprise zone 200. The firewall 214 can be configured to allow the programmatic, or autonomous, communications in most instances to pass through the firewall 214 but limit or prevent the user-initiated communications from passing through the firewall 214.

In FIG. 2A, there are first, second and third Operating Zones 224, 234, and 244 depicted. Each of the Operating Zones 224, 234 and 244 is comprised of a group of automated manufacturing devices such as the OT devices described above. Associated with each of the Operating Zones 224, 234, 244 is a respective host machine, or line box, 222, 232, 242 that secures the Operating Zone. A host machine or line box 222, 232, 242 may comprise a processor and a memory storing instructions that are accessible and executable by that processor. In conjunction with the respective Operating Zones 224, 234, 244, the host machines 222, 232, 242 create three different Secured Operating Zones within the manufacturing Zone 250. As described herein, within the context presented, the operating zones 224, 234, 244 can also be referred to as secured operating zones because of the presence of and being secured by the host machines 222, 232, 242. Also, there is a distinct and separate communication path between each of the host machines 222, 232, 242 via a separate, respective one of the network access devices 220, 230, 240 that connects with the one or more network access devices 216. In at least some contemplated embodiments, the network access devices 220, 230, 240 can be combined into so as to be integral with its corresponding host machine 222, 232, 242. FIG. 2A depicts that a communication path exists between the first Operating Zone 224 and the system 210 effecting the secure access management function 271, wherein the communication path is defined by the host machine 222, the network access device 220, network connections 251 and 253, one of the one or more network access devices 216, another network connection 255, the manufacturing firewall 214, and the network connection 257. FIG. 2A also depicts that a communication path exists between the second Operating Zone 234 and the system 210, wherein the communication path is defined by the host machine 232, the network access device 230, the network connections 251 and 253, one of the one or more network access devices 216, the network connection 255, the manufacturing firewall 214, and the network connection 257. FIG. 2A still further depicts that a communication path exists between the third Operating Zone 244 and the system 210, wherein the communication path is defined by the host machine 242, the network access device 240, the network connections 251 and 253, one of the one or more network access devices 216, the network connection 255, the manufacturing firewall 214, and the network connection 257. As described below, communications to and from each line box, or host machine, 222, 232, 242 can be limited to its defined communication path.

Because of the association of each host machine 222, 232 or 242 on a corresponding network (shown and described with respect to FIG. 2B) with its associated Operating Zone 224, 234 or 244, each host machine 222, 232 or 242 can act as a Network Intrusion Detection System (NIDS) and a Network Intrusion Prevention System (NIPS) for that operating zone. This is because all communication by OT devices into, out-from or within a secured operating zone 224, 234 or 244 must go through its corresponding host machine 222, 232 or 242, except for some limited intra-device communications within a secured operating zone, as described above. Accordingly, the host machines 222, 232 and 242 can monitor and manage communications by the contemporary business systems and other non-host based OT devices within its operating zone 224, 234, 244. For example, the host machines 222, 232 and 242 may block incoming or outgoing communications between the OT devices within its corresponding operating zone and devices outside of the operating zone. Alternately, the host machines may monitor one or more communication characteristics of the OT devices (e.g., ARP requests, DCHP requests) within its corresponding operating zone 224, 234, 244 so that it detects attempts made by any of the OT devices to establish additional connectivity beyond its connectivity to the host machine (such as an external internet connection). As a result, in the event of a potential IS problem, e.g., Malware, active hacker, etc., within a secured operating zone 224, 234 or 244, the corresponding host machine 222, 232 or 242 can completely cut off all communications through the host machine 222, 232 or 242, effectively “containing” or isolating the threat to the secured operating zone 224, 234 or 244. As for communications associated with contemporary business systems and other non-host based OT devices within a secure operating zone, the corresponding line box, or host machine, 222, 232 or 242 can detect communications that inadvertently result from unwanted communications (e.g., ARP requests, DCHP requests, etc.) within the secured operating zone even if all of the communications between the resources within the secured operating zone are not directly monitored by a corresponding host machine 222, 232 or 242.

FIG. 2A also depicts a communication-capable resource 229 that a user may wish to use in conjunction with one or more OT devices within one of the secured operating zones 224, 234, 244. For example, a technician may have updated firmware for one of the OT devices on the communication-capable resource 229. The secure access management function 271 can provide two benefits in such an example. The updated firmware may be on, for example, a USB drive, defining the communication-capable resource 229. The updated firmware may also be on a laptop computer, a processor-based diagnostic device or any other of a variety of communication-capable resources. First, the IS software resident, and maintained, on the data processing system 210 can be used to scan the USB drive or monitor any communications to or from another communication-capable resource 229, e.g., a laptop computer, for the presence or activity of malicious software. Secondly, the data processing system 210 along with credentials (e.g., user name, password and/or encrypted key, etc.) and other information accessible from the storage 212 can be used to access an appropriate one of the host machines 222, 232, 242. The host machines 222, 232, 242 can be configured by IT personnel or OT personnel to only accept inbound communications from the data processing system 210 and only using certain predefined credentials. Thus, an inbound communication path from the communication-capable resource 229 can be defined by a communication path that includes one of the host machines 222, 232, 242 and includes a communication channel between that host machine and the data processing system 210, and wherein the communication-capable resource 229 must communicate with the data processing system 210.

Within FIG. 2A, there are other communication-capable resources depicted as well. The dedicated cloud 218 can receive communications from the enterprise network 208 through the manufacturing firewall 214. As mentioned above, such access through the firewall 214 for communications from the enterprise network 208 can be permitted for programmatic or autonomous communications while prevented for user-initiated communications. It is also contemplated that the firewall 214 may be configured to allow user-initiated communications from the enterprise network 208 to pass through the firewall 214. In such an example, the user-initiated communications from the enterprise network, if attempted with one of the secured operating zones 224, 234, 244, would be prevented by the appropriate host machine 222, 232, 242, unless the user-initiated communication from the enterprise network first passes through the data processing system 210. Programmatic/autonomous communications from the enterprise network, if attempted to be sent to one of the secured operating zones 224, 234, 244, could first pass through the firewall 214 as noted above and could further be allow to pass through by the corresponding host machine 222, 232, 242 without first passing through the data processing system 210, if the corresponding host machine is configured by IT personnel to pass programmatic/autonomous communications without those communications first passing through the data processing system 210. Also, data collected by one or more OT devices within a secured zone, if permitted by its corresponding host machine, can be communicated to the local cloud 218 for potentially being uploaded to the enterprise network 208 in batches, without having to pass through the data processing system 210. Outbound communications from one or more of the OT devices within one of the secured operating zones 224, 234, 244 may also be communicated through the manufacturing firewall 214 to the enterprise network 208 as well, without having to pass through the data processing system 210 but must be permitted by its corresponding host machine, i.e., the corresponding host machine is configured by IT personnel to pass such outbound communications from the OT devices. In the above examples, the local cloud 218 and/or systems (e.g., 202, 206) coupled with the enterprise network 208 can be considered to be communication-capable resources. However, regardless of where the outbound communications from one of the secured operating zones 224, 234, 244 may ultimately be destined, the communication path used by the OT devices within one of the secured operating zones 224, 234, 244 will include an appropriate one of the host machines 222, 232, 242.

In addition, each host machine 222, 232 or 242 can monitor the communications of the group of automated devices within its corresponding secured zone 224, 234 or 244 and send an alert if there is any anomalous communications within its secured operating zone 224, 234 or 244. The group of automated devices can include more traditional OT devices without complicated, host-based operating systems and IS capabilities as well as OT devices which are host-based and execute contemporary business operating systems. As described herein, communications within a secured operating zone 224, 234 or 244 can include communication attempts by a device to connect to a system, computer, device, etc. external to the secured operating zone 224, 234 or 244 or can include intra-device communications between one or more devices within the secured operating zone 224, 234 or 244 (even though those communications can still include the host machine).

FIG. 2B is a block level diagram inside of a secured operating zone according to the principles of the present disclosure. For example, the OT devices 285, 287, 289 within a secured operating zone 224, 234 or 244 (e.g., 224 in FIG. 2B) can be coupled to an internal network 281 within the secured operating zone 224, 234 or 244 that allows the different OT devices 285, 287, 289 to communicate with one another. For monitoring intra-device communications, the host machine 222, 232 or 242 (e.g., 222 in FIG. 2B) can connect with a network tap or a mirrored network port on a network access device 283 so that the intra-device communications can be monitored.

In one example, the host machine 222, 232 or 242 can maintain a “fingerprint” of the communications of the devices within its corresponding secured operating zone 224, 234 or 244 and can send an alert whenever there is a deviation from this fingerprint. A “fingerprint” may comprise expected communications traffic patterns or expected communications characteristics of any of the devices within the secured zone network 281. For example, an expected communication characteristic or pattern can include one of data volume, data content, data destination location, or a change in the group of automated devices communicating with the host machine. The expected fingerprint may be determined by virtue of programming or may be “learned” by the host machine based on historical communications patterns and/or characteristics. More generally, the expected fingerprint may be “established” by such a learning algorithm or by previously learned algorithms or stored algorithms which can be shared with a host machine 222, 232, 242. Once a secured operating zone 224, 234 or 244 is operational, the fingerprints are relatively steady and unchanging over time, so any modifications to the communications of any of the devices within the secured operating zone (i.e. a device is unplugged and/or a replacement/alternate device is plugged in) will produce an alert. An alert can comprise a message sent to an automated log (for example, the local cloud 218), a message sent to an administrative personnel, or both and can include an action such as disabling the network connection on the host machine 222, 232 or 242, thereby isolating the secured operating zone 224, 234 or 244 from inbound or outbound network traffic. Disabling the network connection on the host machine 222, 232, 242 would typically involve disabling the network interface card of the host machine. Disabling the host machine 222, 232 or 242 in this manner isolates the secured operating zone 224, 234 or 244 from the enterprise zone 200, the system 210 effecting the secure access management function 271, and the other ones of the secured operating zones 224, 234, 244.

Unlike general computing environments in which a user can commonly access and then disconnect from different physical networks, i.e., a coffee shop network, business network, home network, manufacturing industrial control systems (ICS) permanently connect to network(s) needed to operate the manufacturing or OT devices. Thus, within a secured operating zone 224, 234 or 244, these connections will not typically change and therefore if a host machine 222, 232 or 242 detects a new network connection or a new device being connected to the secured operating zone 224, 234 or 244, the host machine 222, 232 or 242 can readily recognize a deviation from the corresponding fingerprint such as, for example, the new network or device connection. Similarly, the types of connections being used within each secured operating zone 224, 234 or 244 are generally static and do not change; i.e., the PLC connects to the motor controller and other usual ICS equipment. So, if the PLC suddenly begins to communicate to a completely different system, this communication will comprise an anomalous communication that is cause for suspicious activity and outside the normal “fingerprint” of network connections and communications.

Thus, the environment of FIG. 2A and FIG. 2B illustrate an IS Architecture for a Manufacturing Zone 250 that includes secured operating zones 224, 234 and 244, each containing contemporary business systems and other non-host based OT devices, wherein the contemporary business systems and other non-host based OT devices are also referred to herein as a group of “automated manufacturing devices” or “automated devices”. Each secured operating zone 224, 234 or 244 is connected to the rest of the network of the enterprise. through a corresponding host machine 222, 232 or 242 and communications within the secured operating zone 224, 234 or 244 are limited so that no connectivity exists other than a single connection of each OT device in the secured operating zone 224, 234 or 244 to and from the host machine 222, 232 or 242 (other than intra-device connections between OT devices to permit the OT devices to function in concert to perform the desired capabilities within a manufacturing line or manufacturing cell). Embodiments in accordance with the principles of the present disclosure contemplate that a secured operating zone may also connect to another secured operating zone and not just the enterprise, i.e., secured operating zone 224 may communicate to/with secured operating zones 234 and/or 244. There may also be “nested” secure operating zones, in other words, one or more secured operating zones inside a secure operating zone.

The configuration illustrated in FIG. 2A and FIG. 2B provides a solution that is based, generally, on isolation, limited connectivity, protection, and monitoring. As described above, isolation can be achieved by elimination of direct user connections with OT devices within the secured operating zones 224, 234 and 244.

Normally, there are multiple possible direct user connections on any one of the automated manufacturing devices, or simply “devices”, but in the secured operating zones 224, 234, 244 these possible direct user connections are eliminated, such that an inbound connection or a direct connection to an automated manufacturing device within the secured zone 224, 234, 244 will only be permitted via the corresponding host machine 222, 232 or 242. For user-initiated communications from the enterprise network 208 or the communication-capable resource 229, those communications will only be permitted via the system 210 effecting the secure access management function 271. As mentioned above, the manufacturing firewall 214 can be configured to provide different permissiveness to different types of communication between the manufacturing zone 250 and the enterprise zone 200. As also noted above, at least some programmatic/autonomous communications from the enterprise network 208, if attempted to be sent to one of the secured operating zones 224, 234, 244, could be allowed to pass through by the corresponding host machine 222, 232, 242 without first passing through the data processing system 210, if the corresponding host machine is configured by IT personnel to pass those programmatic/autonomous communications without those communications first passing through the data processing system 210. An automated manufacturing device for use within a secured operating zone 224, 234 or 244 may be provided as having the capacity for, for example, one or more Wi-Fi connections, connections via one or more serial ports, Bluetooth connections, network connections, etc. At least some of these connection capabilities can be disabled in the secured zones, such as manually by an administrative personnel. Some of the connections may be programmatically disconnected or disabled using a computer-based or processor-based system that can access configuration functions within the automated manufacturing device. The present disclosure contemplates that these connections will be eliminated, such that a user-initiated inbound connection from outside the manufacturing zone 250 to an automated manufacturing device within a secured zone will only be permitted via the system 210 effecting the secure access management function 271. In other words, direct inbound user-initiated connections to an automated manufacturing device are “Un-Trusted” and not permitted. A user of the system 210 with access to specific credentials related to the secured operating zones 224, 234, 244 will be permitted to use the system 210 to effect the secure access management function 271 such that only communications from that system 210 when those credentials are used will be allowed to pass through to the host machines 222, 232 and 242 and the automated manufacturing devices within the secured operating zones 224, 234 and 244. Thus, even though a user may be able to login to the system 210 or connect with the system 210 for other purposes, they may not be able to communicate with the secured operating zones 224, 234, 244 unless they are also able to utilize the specific credentials created to allow such access to the automated manufacturing devices within the secured zones.

Accordingly, each host machine 222, 232 or 242 can implement IDS/IPS technology to monitor all communications of the devices within its corresponding secured operating zone 224, 234 or 244. The communications characteristics and patterns of these devices can be compared with the “fingerprint” described above. The fingerprint may be programmed into the host machine, or established over time (e.g. “learned”) by the host machine.

During a training phase, the host machines 222, 232 and 242 can learn what are the normal communications patterns and characteristics that can be expected by the automated manufacturing devices within their respective secured operating zones 224, 234 and 244. A new training phase may be initiated each time a new device is added to, removed from, or modified for, the secured operating zone. A subject matter expert can review the “learning process” of each of the host machines 222, 232 or 242 and ensure that each host machine 222, 232 or 242 learns an expected fingerprint of the network traffic for its corresponding secured operating zone 224, 234 or 244. As described herein, communication characteristics or traffic patterns that are learned can include information about one of data volume, data content, data destination location, or a change in the group of automated devices communicating with the host machine. Software such as packet sniffers and network traffic analyzers can be configured by IT personnel, or OT personnel, to collect the raw information over a period of time and determine example communication characteristics related to different times of the day, different days of the week, average traffic volumes from each OT device, average traffic volumes to certain destinations, etc. In this manner, each host machine 222, 232, 242 with almost no additional user intervention can automatically “learn” a fingerprint for its corresponding secured operating zone 224, 234, 244.

IDS and IPS technology can include commercially available off-the-shelf technology. IDS (Intrusion Detection System) technology inspects all communications traffic for a secured operating zone 224, 234 or 244 and can also produce an alert when there are communication anomalies such as well-known malware/hacker signatures within the monitored network traffic.

IPS (Intrusion Prevention System) technology may then enforce the fingerprinted traffic depending on criticality of the one or more OT devices operating within the secured zone. In the event of a fingerprint deviation or apparent cybersecurity event, a secured zone's external network connection (e.g., via one of the host machines 222, 232 or 242) may be disconnected (manually or automatically) in such a way as to allow limited continuation of an OT process or at least a safe shutdown. In the cybersecurity world this is commonly referred to as “System Containment” which prevents the cybersecurity event (hacker activity, malware, etc.) from spreading to other areas within the enterprise or even corporate wide.

The step of “protection” can be achieved by a host machine 222, 232 or 242 by monitoring communications characteristics and traffic patterns of the automated devices within its corresponding secured operating zone 224, 234 or 244 and comparing the monitored patterns and characteristics with its corresponding secured zone fingerprint, wherein the host machine 222, 232 or 242 runs locally and is physically present in or near the corresponding secured zone 224, 234 or 244 as shown in FIG. 2A. Embodiments in accordance with the present disclosure also contemplate that such functionality can alternatively be achieved with a cloud based approach in which similar protection systems run in the cloud using cloud-based technology accessible by the system 210 effecting the secure access management function 271.

Each host machine 222, 232 or 242 can execute commercially available software to perform the described functions, such as firewalls so as to explicitly allow only communication into, out-from and within its corresponding secured operating zone 224, 234 or 244 to occur that is required for the secured operating zone to be effective and to perform the IDS and IPS functions as described above. Two example open-source firewalls include IPTables and pfSense but use of many other firewalls or applications/hardware with similar functionality are contemplated as well. Furthermore, the software executing on each host machine 222, 232 or 242 can include log forwarding and monitoring systems to collect logs (security, event, application, etc. logs). These various logs will then be sent to various monitoring systems to provide additional information about the status and health of the OT systems within the secured zones.

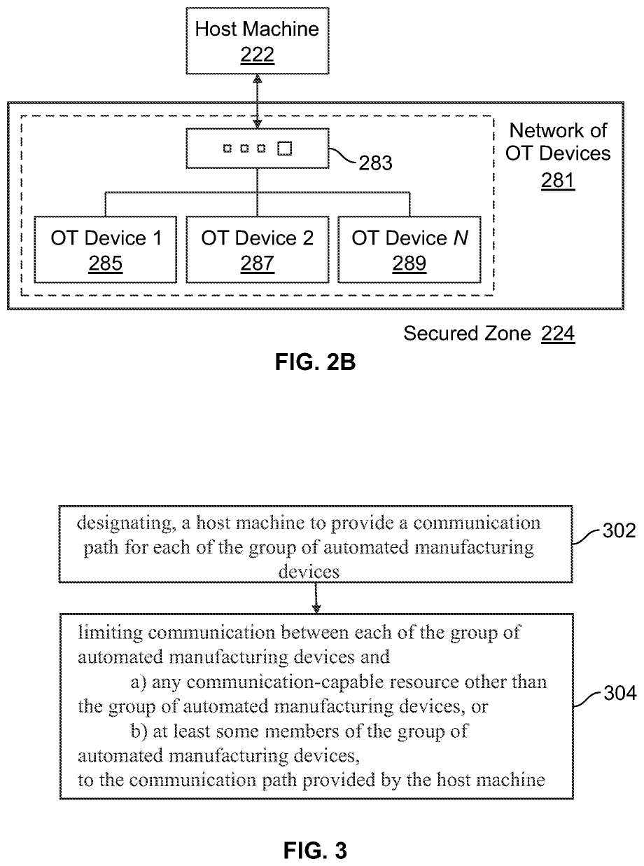

FIG. 3 depicts one method according to the principles of the present disclosure and relates to a processor-implemented method of increasing security of a group of automated manufacturing devices.

In step 302, the method begins with the step of designating, by a processor, a host machine to provide a communication path for each of the group of automated manufacturing devices. This communication path can be for each of the group of automated manufacturing devices and a communication-capable resource. In general, however, the processor may be optional and unnecessary to designate the host machine as this step could be performed by IT personnel or OT personnel. As described above, the optional processor can comprise the processor 211 of the system, or processor-based device, 210 effecting the secure access management function 271 and the designated host machine can be one of the host machines 222, 232 or 242. Within a secured operating zone 224, 234 or 244, there are a group of automated manufacturing devices such as contemporary business systems and other non-host based OT devices. Also, as described with respect to FIG. 2A, a communication-capable resource can include a resource 229 that a user wants to utilize to communicate with one or more of the automated manufacturing devices within one of the secured operating zones 224, 234, 244. Using the example of the communication capable resource 229, the communication path would likely be an inbound connection into one of the secured operating zones 224, 234, 244 through the appropriate host machine 222, 232, 242. This communication path can be a one-way communication path into, out-from, or within the secured operating zone or a two-way communication into and out of the secured operating zone, as described above. To reiterate though, regardless of the type of communication path used, the traffic passes through one of the host machines 222, 232, 242.

In step 304, the method continues with limiting communication, between each device of the group of automated manufacturing devices and a) any communication-capable resource other than the group of automated manufacturing devices, or b) at least some members of the group of automated manufacturing devices, to the communication path provided by the host machine. In group “a)”, the limited communication involves communication-capable resources which are outside of the group of automated manufacturing devices. As an example, referring to FIG. 2A, such a communication-capable resource can include the resource 229. In group “b)”, the limited communication involves at least some of the other devices of the group of automated manufacturing devices. As an example, referring to FIG. 2B, such devices can include the different OT devices 285, 287, 289.

With reference to FIG. 2A, each host machine 222, 232 or 242 provides a limited communication path available for the automated manufacturing devices within its corresponding secured operating zone 224, 234 or 244. Thus, the communication path for an automated manufacturing device (or one of the group of automated manufacturing devices) is limited to the communication path provided by its corresponding host machine 222, 232 or 242. Thus, communications between the one of the automated manufacturing devices and an external communication-capable resource or between the one of the automated manufacturing devices and at least some of the other automated manufacturing devices within the secured zone is limited to the communication path provided by the host machine 222, 232 or 242 corresponding to the secured operating zone 242, 234 or 244 in which the automated manufacturing device is located. As mentioned above, the limiting of the communication path can include manual manipulation or physical configuration of an automated manufacturing device or can include programmatic manipulation, such as through a computer-accessible configuration function available through the automated manufacturing device. The programmatic manipulation can, for example, be accomplished via a user utilizing the system 210 for effecting the secure access management function 271.

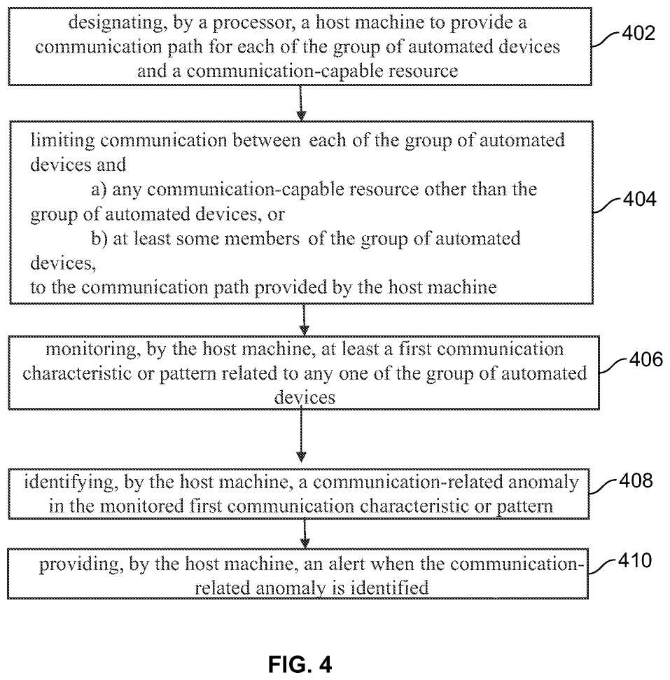

FIG. 4 depicts another method according to the principles of the present disclosure. Steps 402 and 404 are substantially analogous to the steps 302 and 304, respectively, of FIG. 3.

In addition, the method of FIG. 4 continues with step 406 by monitoring, by the host machine 222, 232 or 242, at least a first communication pattern or characteristic related to any one of the group of automated devices secured by the host machine and, in step 408, by identifying, by the host machine, a communication-related anomaly in the monitored first communication characteristic or pattern. As described above, each host machine 222, 232 or 242 can learn what communications patterns and characteristics are expected or anticipated to be present within its corresponding secured operating zone 224, 234 or 244. Such communications can include communications traffic by (into, out-from or within the secured zone) or characteristics of, any of the automated manufacturing devices in the secured operating zone 224, 234 or 244. The expected communications characteristics and patterns can be referred to as a “fingerprint” and because of the nature of the manufacturing cells or lines and the automated devices within manufacturing cells or lines, the fingerprint for a secured operating zone is relatively static. The monitored first communication characteristic or pattern can include for example, one of data volume, data content, data destination location, or a change in the group of automated devices communicating with the host machine. A fingerprint can include a single learned communication characteristic or pattern but can also be more robust and include a plurality of different communication characteristics or patterns. Thus, an anomaly as compared to a fingerprint can be defined to be when any one of the one or more monitored communication characteristics or patterns deviate or differ from an expected communication characteristic or pattern within the fingerprint.

As just mentioned, a communication-related anomaly can be identified when the monitored communications within a secured operating zone 224, 234 or 244 differs from an expected communication characteristic or pattern defining part of the fingerprint. The term “differs” can include a statistical component such that deviations from the fingerprint less than a particular amount (e.g., 10%) are not considered an anomaly. Furthermore, if, after establishing the “fingerprint,” the host machine 222, 232 or 242 determines that a particular communication characteristic and/or pattern is different than what was initially established, then the fingerprint can be adjusted, for example by programming or by initiating a training phase, to include the new communication characteristic and/or pattern such that anomalies are determined based on the newly determined communication characteristic and/or pattern rather than the initially learned communication characteristic and/or pattern. An anomaly typically occurs if there is a security-related breach of one of the automated manufacturing devices within one of the secured operating zones 224, 234, 244. However, a misconfiguration of an automated manufacturing device may also result in too-little or too-much traffic by volume to a particular other device. Thus, an “anomaly” may not be limited to simply security-related problems.

The method of FIG. 4 concludes in step 410 by providing, by the host machine, an alert when the communication-related anomaly is identified. As mentioned above, an alert can include a message and/or an action. The action, for example, can be to disable the communication capability of the host machine 222, 232 or 242 so as to isolate its corresponding secured operating zone 224, 234 or 244 from communicating with any other systems within the enterprise (e.g., the IT zone 200 or other host machines in the manufacturing zone 250).

As mentioned above, with respect to steps 406 and 408, the method of FIG. 4 includes establishing, such as by programming or by learning, by the designated host machine an expected communication characteristic and/or pattern which defines at least part of a corresponding communication fingerprint of the group of automated devices; and wherein detecting the anomaly comprises identifying a deviation of the first or currently measured or monitored communication characteristic and/or pattern from the expected or previously learned communication characteristic and/or pattern.

Further, the method of FIG. 4 can include the provision that the communication path provided by the host machine comprises a communication channel between the processor (e.g., processor 211 of processor-based device or processing system 210) and the host machine (e.g., 222) such that communication between any communication-capable resource and the automated devices within the secured zone corresponding to the host machine is limited to the processing system 210 and the communication channel. In this way, incoming communications to the automated manufacturing devices within the secured operating zone can be restricted to arriving only from the processing system 210.

While some of the automated manufacturing devices within a secured operating zone can include its own anti-virus capability, its own malware-related capability, its own security-related capability, in some embodiments, at least some of the secured zones 224, 234, 244 can include, for example, OT devices that include an operating system without anti-virus capability or without security-related capability. In some embodiments, the automated manufacturing devices within a secured operating zone 224, 234, 244 may include only contemporary business systems and not include any non-host-based OT devices.

In accordance with the principles of the present disclosure, the group of automated devices may define a manufacturing operation. The manufacturing zone 250 can include a plurality of manufacturing operations 224, 234 and 244 that define secured operating zones 224, 234 and 244 and each of these manufacturing operations can be associated with a single, respective host machine 222, 232, 242, as described above.

Embodiments in accordance with the present disclosure contemplate a wide variety of possible manufacturing operations that, for example, can include unloading, storage, retrieval and delivery of raw, discrete component and packing materials; assembly of discrete assembled products; converting of web based products; making of formulated products; packing of discrete, web and formulated products; storage, retrieval and loading of packed finished product; and/or storage, retrieval and loading of bulk finished product

As mentioned above, each host machine 222, 232 or 242 can also monitor communication traffic patterns and/or characteristics of the automated devices within its corresponding secured zone 224, 234 or 244. Thus, the method of FIG. 4 can be optionally expanded to include monitoring, by the host machine, at least a second communication characteristic related to any one or more of the group of automated devices; and identifying, by the host machine, any communication-related anomaly in the monitored second communication characteristic. The second communication characteristic can include one of data volume, data content, data destination location, or a change in the group of automated devices communicating with the host machine, which is different from the first communication characteristic.

Similar to steps described earlier, the host machine can learn a further expected communication characteristic or pattern related to one or more of the group of automated devices and the others of the group of automated devices such that detecting the anomaly comprises identifying a deviation of the monitored second communication characteristic of the further expected communication characteristic or pattern.

Referring to FIG. 5, a block diagram of a data processing system 500 is depicted in accordance with the present disclosure. The data processing system 500, such as may be utilized to implement the data processing system, or processor-based device, 210 and/or the host machines 222. 232, and 242, e.g., as set out in greater detail in FIG. 1-FIG. 4, may comprise a symmetric multiprocessor (SMP) system or other configuration including a plurality of processors 502 connected to system bus 504. Alternatively, a single processor 502 may be employed. Also connected to system bus 504 is a memory controller/cache 506, which provides an interface to local memory 508. An I/O bridge 510 is connected to the system bus 504 and provides an interface to an I/O bus 512. The I/O bus may be utilized to support one or more busses and corresponding devices 514, such as bus bridges, input output devices (I/O devices), storage, network adapters, etc. Network adapters may also be coupled to the system to enable the data processing system to become coupled to other data processing systems or remote printers or storage devices through intervening private or public networks.

Also connected to the I/O bus may be devices such as a graphics adapter 516, storage 518 and a computer usable storage medium 520 having computer usable program code embodied thereon. The computer usable program code may be executed to execute any aspect of the present disclosure, for example, to implement aspect of any of the methods, computer program products and/or system components illustrated in FIG. 1-FIG. 4 The data processing system 500, or aspects thereof, can also be utilized to implement one or more of the automated manufacturing devices within a manufacturing line or cell 224, 234, and 244.

The flowchart and block diagrams in the Figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A processor-implemented method of increasing security of a group of automated devices comprising:
designating, by a processor, a host machine to provide a communication path for each of the group of automated devices and a communication-capable resource;
limiting communication between each of the group of automated devices and
a) any communication-capable resource other than the group of automated devices, or
b) at least some members of the group of automated devices,
to the communication path provided by the host machine;
monitoring, by the host machine, at least a first communication characteristic or pattern related to any one of the group of automated devices;
identifying, by the host machine, a communication-related anomaly in the monitored first communication characteristic or pattern; and
providing, by the host machine, an alert when the communication-related anomaly is identified.

2. The processor-implemented method of claim 1, further comprising:
establishing by the designated host machine an expected communication characteristic or pattern related to one or more of the group of automated devices; and
wherein identifying the communication-related anomaly comprises identifying a deviation of the monitored first communication characteristic or pattern from the expected communication characteristic or pattern.

3. The processor-implemented method of claim 1, wherein the communication path provided by the host machine comprises a communication channel between the processor and the host machine such that communication between any communication-capable resource and at least one automated device of the group of automated devices is limited to the processor and the communication channel.

4. The processor-implemented method of claim 1, wherein the alert comprises disabling, by the processor or the host machine, the communication channel.

5. The processor-implemented method of claim 1, wherein at least one of the group of automated devices comprises an operating system without anti-virus capability.

6. The processor-implemented method of claim 1, wherein at least one of the group of automated devices comprises an operating system without security-related capability.

7. The processor-implemented method of claim 1, wherein the group of automated devices are networked with one another to provide a logical functional element.

8. The processor-implemented method of claim 7, wherein the group of automated devices define a manufacturing operation.

9. The processor-implemented method of claim 2, further comprising:
monitoring, by the host machine, at least a second communication characteristic or pattern related to communications within the group of automated devices; and
identifying, by the host machine, a communication-related anomaly in the monitored second communication characteristic or pattern.

10. The processor-implemented method of claim 1, wherein the first communication characteristic or pattern comprises one of data volume, data content, data destination location, or a change in the group of automated devices.

11. The processor-implemented method of claim 1, wherein the communication path for each of the group of automated devices and a communication-capable resource comprises a two-way communication path.

12. The processor-implemented method of claim 1,
wherein identifying the communication-related anomaly comprises identifying a malware signature in the monitored first communication characteristic or pattern.

13. A processor-implemented method of increasing security of a group of automated manufacturing devices comprising:
designating a host machine to provide a communication path for each of the group of automated manufacturing devices; and
limiting communication between each of the group of automated manufacturing devices and
a) any communication-capable resource other than the group of automated manufacturing devices, or
b) at least some members of the group of automated manufacturing devices,
to the communication path provided by the host machine.

14. A system for increasing security of a group of automated devices comprising:
a processor-based device comprising:
a first memory device storing first executable instructions; and
a first processor in communication with the first memory device;
a host machine comprising:
a second memory device storing second executable instructions; and
a second processor in communication with the second memory device;
wherein the first processor, when executing the first executable instructions, designates the host machine to provide a communication path for each of the group of automated devices and wherein connectivity is limited to the communication path provided by the host machine for communications between each of the group of automated devices and
a) any communication-capable resource other than the group of automated devices, or
b) at least some members of the group of automated devices; and
wherein the second processor, when executing the second executable instructions:
monitors at least a first communication characteristic or pattern related to any one of the group of automated devices and the host machine;
identifies a communication-related anomaly in the monitored first communication characteristic or pattern; and
provides an alert in response to the communication-related anomaly.

15. The system of claim 14, wherein the second processor, when executing the second executable instructions:
establishes an expected communication characteristic or pattern related to one or more of the group of automated devices; and
wherein identifying the communication-related anomaly comprises identifying a deviation of the monitored first communication characteristic or pattern from the expected communication characteristic or pattern. 16 The system of claim 14, wherein the communication path provided by the host machine comprises a communication channel between the processor-based device and the host machine such that communication between any communication-capable resource other than the group of automated devices and the host machine is limited to the processor-based device and the communication channel.

17. The system of claim 16, wherein either the first processor, when executing the first executable instructions or the second processor, when executing the second executable instructions:
disables the communication channel in response to the security-related anomaly.

18. The system of claim 14, wherein at least one of the group of automated devices comprises an operating system without anti-virus capability.

19. The system of claim 14, wherein at least one of the group of automated devices comprises an operating system without security-related capability.

20. The system of claim 14, wherein the group of automated devices are networked with one another to provide a logical functional element.

21. The system of claim 20, wherein the group of automated devices define a manufacturing operation.

22. The system of claim 15, wherein the second processor, when executing the second executable instructions:
monitors at least a second communication characteristic or pattern related to communications within the group of automated devices; and
identifies a communication-related anomaly in the monitored second communication characteristic or pattern.

23. The system of claim 14, wherein the first communication characteristic or pattern comprises one of data volume, data content, data destination location, or a change in the group of automated devices communicating with the host machine.

24. The system of claim 14, wherein the communication path for each of the group of automated devices and a communication-capable resource comprises a two-way communication path.

25. The system of claim 14, wherein identifying the communication-related anomaly comprises identifying a malware signature in the monitored first communication characteristic or pattern.

26. A system for increasing security of a group of automated manufacturing devices comprising:
a processor-based device comprising:
a first memory device storing first executable instructions, and
a first processor in communication with the first memory device;
a host machine comprising:
a second memory device storing second executable instructions, and
a second processor in communication with the second memory device; and
wherein the first processor, when executing the first executable instructions, designates the host machine to provide a communication path for each of the group of automated manufacturing devices and wherein connectivity is limited to the communication path provided by the host machine for communications between each of the group of automated manufacturing devices and
a) any communication-capable resource other than the group of automated manufacturing devices, or
b) at least some members of the group of automated manufacturing devices.
